(19) United States
(12) Patent Application Publication
(10) Pub. No.: US 2019/0288326 A1
(43) Pub. Date: Sep. 19, 2019

(54) SODIUM ION BATTERY CATHODES

(71) Applicant: Massachusetts Institute of Technology, Cambridge, MA (US)

(72) Inventors: Angela Belcher, Lexington, MA (US); Jifa Qi, West Roxbury, MA (US); Shuya Wei, Brighton, MA (US)

(73) Assignee: Massachusetts Institute of Technology, Cambridge, MA (US)

(21) Appl. No.: 16/355,810

(22) Filed: Mar. 17, 2019

Related U.S. Application Data
(60) Provisional application No. 62/644,389, filed on Mar. 17, 2018.

(51) Int. Cl. H01M 10/054; H01M 4/525; H01M 4/505; C01G 53/00

(52) U.S. Cl. CPC H01M 10/054; H01M 4/525; H01M 2004/021; C01G 53/44; H01M 4/505

(57) ABSTRACT

A sodium ion battery can include a biotemplated anode material.

### PRIORITY CLAIM

This application claims priority to U.S. Application No. 62/644,389, filed Mar. 17, 2018, which is incorporated by reference in its entirety.

### FIELD OF THE INVENTION

The invention relates to compositions suitable for cathodes for batteries.

### BACKGROUND

A battery includes an anode and a cathode material. Batteries can be rechargeable.

### SUMMARY

In one aspect, a composition can include a NaTMO₂ layered oxide, wherein TM is one or more transition metals. A portion of the TM content can be optionally substituted by an environmentally friendly metal, such as iron, tin, silicon or titanium.

In another aspect, a battery can include a cathode including a NaTMO₂ layered oxide, wherein TM is one or more transition metals. The battery can include the cathode and an anode, and a separator between the anode and the cathode. The battery can include an electrolyte. The anode can be sodium.

In another aspect, a battery can include a cathode including the NaTMO₂ layered oxide. The battery can be a sodium ion battery. The battery can have an energy density of more than 250 Wh/kg, more than 260 Wh/kg, more than 275 Wh/kg, more than 280 Wh/kg or more than 300 Wh/kg.

In certain circumstances, the NaTMO₂ layered oxide can be a P2-type.

In certain circumstances, the NaTMO₂ layered oxide can be NaNiMnXO₂ where X is Ti, Fe, Sn, or Si.

In certain circumstances, X can be present in a dopant amount in the NaTMO₂ composition. The dopant amount can be up to about 10%, 20%, 30%, 40% or 50% of the TM component of the composition.

In certain circumstances, the NaTMO₂ layered oxide can be templated to a bacteriophage.

In certain circumstances, the NaTMO₂ can have a particle size of between 5 nm and 10 microns.

Other aspects, embodiments, and features will be apparent from the following description, the drawings, and the claims.

### BRIEF DESCRIPTION OF THE DRAWINGS

FIG. 1 depicts a structure and x-ray diffraction pattern of a composition described herein.

FIG. 2A depicts micrographs of a template synthesized composition.

FIG. 2B depicts micrographs of a template synthesized composition.

FIG. 3 depicts electrochemical properties of a composition.

FIG. 4 depicts electrochemical properties of a composition.

FIG. 5 depicts electrochemical properties of a composition.

FIG. 6 depicts electrochemical properties of a composition.

FIG. 7 depicts electrochemical properties of a composition.

FIG. 8 depicts electrochemical properties of a composition.

FIG. 9 depicts a battery.

### DETAILED DESCRIPTION

Sodium-ion batteries (SIBs) have received much attention for large-scale electrochemical energy storage due to the natural abundance, non-toxicity and low cost of sodium resources. See, for example, Armand, M. & Tarascon, J. M. Building better batteries. Nature 451, 652-657 (2008), Kundu, D., Talaie, E., Duffort, V. & Nazar, L. F. The Emerging Chemistry of Sodium Ion Batteries for Electrochemical Energy Storage. Angewandte Chemie International Edition 54, 3431-3448, (2015), and Palomares, V. et al. Na-ion batteries, recent advances and present challenges to become low cost energy storage systems. Energy & Environmental Science 5, 5884-5901, (2012), each of which is incorporated by reference in its entirety. Cathode materials largely determine the energy density, lifespan and the tolerance of SIBs. However, increasing the energy density of advanced SIBs require smart material structure design. Among the cathode candidates, NaTMO₂ layered oxides (TM=transition metal) have attracted intensive attention due to their high energy density and feasible synthesis. See, Park, H., Kwon, J., Choi, H., Song, T. & Paik, U. Microstructural control of new intercalation layered titanoniobates with large and reversible d-spacing for easy Na⁺ ion uptake. Science Advances 3, (2017), which is incorporated by reference in its entirety. In this work, solution phase synthesis of a family of P2-type (prismatic) NaNiMnXO₂ (X=Ti, Sn, Si, Fe . . . ) and their application for high energy sodium ion battery cathodes is shown. In addition, the NaNiMnXO₂ (X=Ti, Sn, Si, Fe . . . ) can be templated to bacteriophage E3 to well control the grain boundary and morphology of the synthesized materials. When applying the synthesized materials as sodium ion battery cathodes, the batteries display long cycle life with over 82% capacity retention after 400 cycles at a high current density of 1C. These cathodes also bear a high average voltage of ˜3.6 V, opening up a new route to design high energy and high rate cathode materials for SIBs.

In particular, a templated NaTMO₂ layered oxide material can have mixed elements as the transition metal component (TM). The transition metal (TM) can include Sc, Ti, V, Cr, Mn, Fe, Co, Ni, Cu, Zn, Y, Zr, Nb, Mo, Tc, Ru, Rh, Pd, Ag, Cd, Hf, Ta, W, Re, Os, Ir, Pt, Au, or Hg. The transition metal can be a mixture of transition metals, including one or more environmentally friendly element. The environmentally friendly element can be, for example, Ti, Sn, Si, or Fe. The mole ratio of the transition metal to environmentally friendly element can be between 10:1 to 1:1, for example, between 5:1 and 2:1. For example, the ratio can be 2:1, 2.5:1, 3:1, 3.5:1, 4:1 or 4.5:1. The composition can include one, two, three or four transition metals. Alternatively, the environmentally friendly element can be present as about 5%, 10%, 15%, 20%, 25%, 30%, 40%, 45% or 50% of the composition. The particle size can be 5 nm to 10 microns, less than 1 micron, less than 100 nm or less than 50 nm.

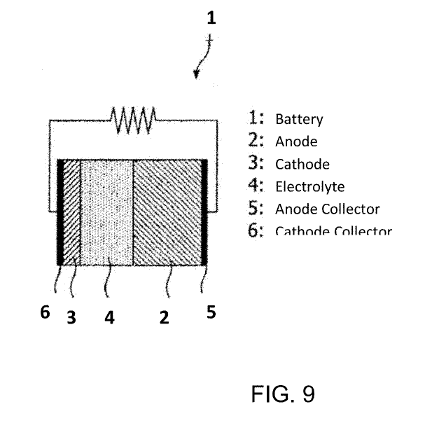

FIG. 9 schematically illustrates a rechargeable metal-air battery 1, which includes anode 2, cathode 3, electrolyte 4, anode collector 5, and, optionally, cathode collector 6.

High-energy sodium ion battery cathodes can be based on earth abundant transition-metal oxides. Batteries including the materials described herein have a number of advantages over prior batteries. For example, several types of high-voltage cathode materials for sodium ion batteries can replace lithium. Also, very few high-performance materials exist that can be used for sodium batteries. In certain circumstances, P2-type NaTMO₂ layered oxides offer high capacities and feasible synthesis that can be used as cathodes for sodium ion batteries. The materials are based on earth-abundant and environment friendly elements: NaNiMnXO₂ (X=Ti, Fe, Sn, Si etc. . . . ). Surprisingly, the doping inactive metal X can eliminate phase transformations and extend the sodium intercalation range, improving battery performance. As a result, high energy density can be achieved (close to 300 Wh/kg), surpassing current lithium ion batteries. By increasing the size of the doping atom, phase transformations can be eliminated. These structural changes also lead to better reversibility due to easier sodium ion intercalation and diffusion inside NaTMO₂. Thus, enhanced stability and capacity can be achieved with appropriate doping. In certain circumstances, cycling performance of Na-NaNMTXO₂ batteries were found to be stable to cycle over 400 times.

In terms of developing electrode materials for sodium ion batteries (SIBs), cathode materials largely determine the energy density, lifespan and the tolerance of SIBs. Due to the larger ionic size of Na, it is challenge to design appropriate host cathode materials that are able to intercalate and deintercalated with sodium ion, therefore, increasing the electrochemical performance of advanced SIBs requires smart design of cathode material structures. Among the cathode candidates, NaTMO₂ layered oxides (TM=transition metal) have attracted intensive attention due to their high energy density and feasible synthesis. Their Na+/vacancy-ordered superstructure depends on the Na concentration when explored in a limited electrochemical window, that largely determines the electrochemical properties like Na⁺ kinetics, voltage plateau and cycling stability of the materials as the cathode for SIBs. In this work, a novel solution phase synthesis of a family of P2-type (prismatic) NaNiMnXO₂ (X=Ti, Sn, Si, Fe . . . ) was demonstrated and their application for high energy sodium ion battery cathodes. By adding different doping atom X, we were able to control Na mobility and Na diffusion barrier in the transition metal oxide compounds, therefore, improving the cycling stability and rate capability of the cathode materials for rechargeable SIBs especially by doping with Ti. Additionally, with the aid of bio-templating, we were able to reduce the size of NaNiMnTiO₂ from micro scale to nano scale, further enhancing the Na⁺ diffusivity in the compound. As a result, it increases the capacity at even higher cycling rate. When applying the synthesized materials as sodium ion battery cathodes, the batteries display long cycle life with good capacity retention after 100 cycles at various current densities. These cathodes also bear a high average voltage of ˜3.6 V, opening up a new route to design high energy and high rate cathode materials for SIBs.

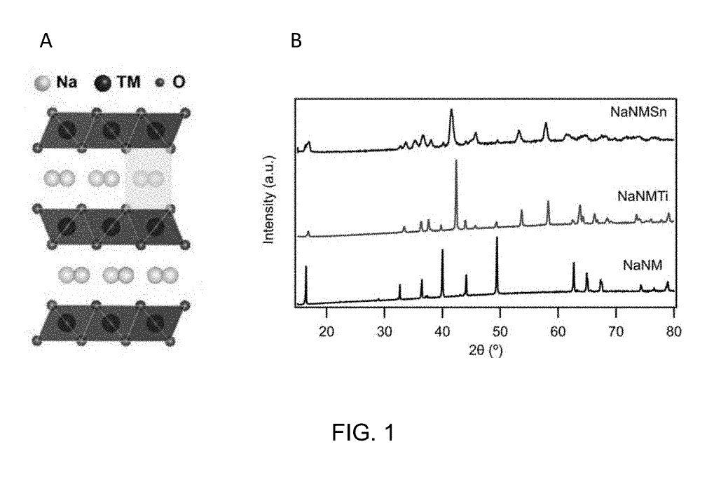

FIG. 1 shows a schematic representation of the crystal structure of P2-type layered transition metal oxides as well as the XRD diffraction pattern of the synthesized NaNiMnXO₂.

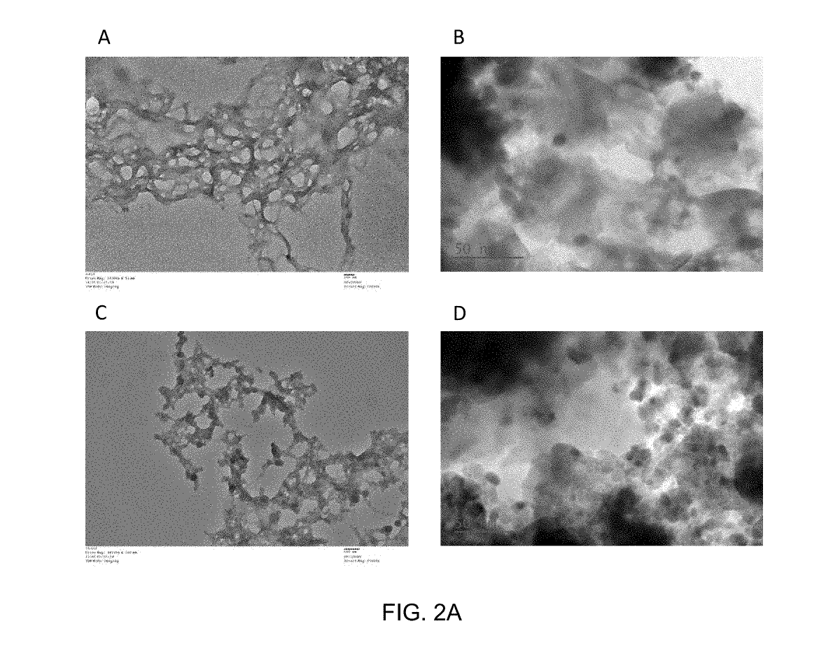

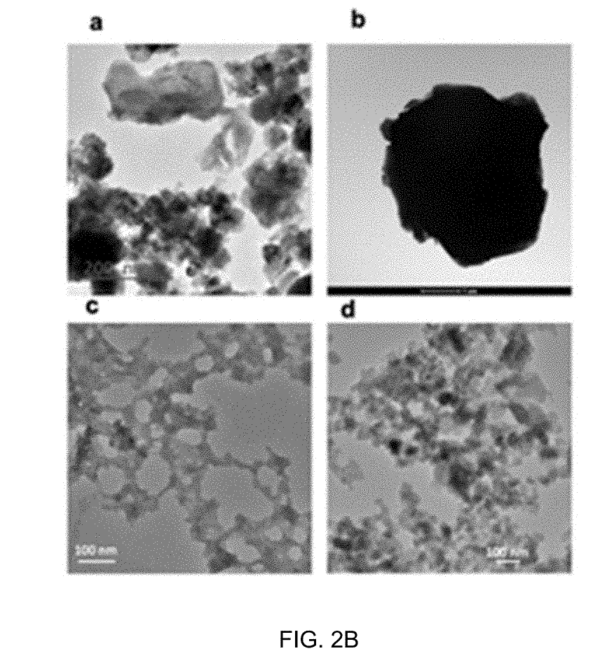

FIG. 2A shows TEM images of the synthesized NaNM (A), virus templated NaNM (B), NaNMTi (C) and virus templated NaNMTi (D).

FIG. 2B shows morphological and structural comparisons between pristine and bio-NaNiMnTiO₂. In particular, FIG. 2B, images (a)-(d) are TEM micrographs showing pristine NaNiMnTiO₂ structural changes due to annealing. FIG. 2B, images (c)-(d) are TEM micrographs showing bio-NaNiMnTiO₂ structural changes due to annealing. Image (a) shows the precursor of NaNiMnTiO₂. Image (b) shows metal oxide compound annealing at 800° C. for 1 hour showing a huge increase in primary particle size. Image (c) shows the precursor of bio-NaNiMnTiO₂. Image (d) shows the morphology of bio-NaNiMnTiO₂ after annealing. Scale bars in image (a) is 200 nm, image (b) is 1 μm, image (c) is 100 nm and image (d) is 100 nm. FIG. 1 shows the XRD diffractograms of pristine NaNiMnXO₂ after annealing with different doping atoms.

To produce nano-structured NaNiMnTiO₂, genetically-engineered multifunctional M13 virus was used as the template to grow the material at room temperature. The developed material has an amorphous structure with an average particle size of about 20 nm, synthesized in a solution-based environment with the aid of the M13 virus. To improve the electrochemical performance, nano-structured NaNiMnTiO₂ has been annealed at 800° C. for 1 hour to crystalize the material. To study the morphology and structure of the synthesized Bio-NaNiMnTiO₂, the material was characterized with transmission electron microscopy (TEM) and powder X-ray diffraction (XRD) techniques (FIG. 1). XRD results show the transformation of the material from amorphous to crystalline structure and TEM confirms the morphology (nanowire) and nano-structured (about 20 nm) characteristics of the bio-NaNiMnTiO₂ after annealing.

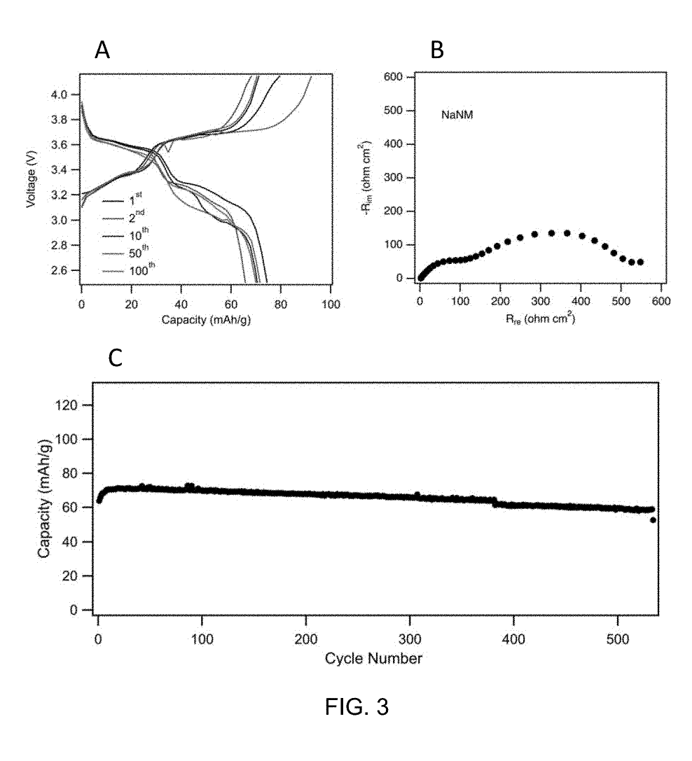

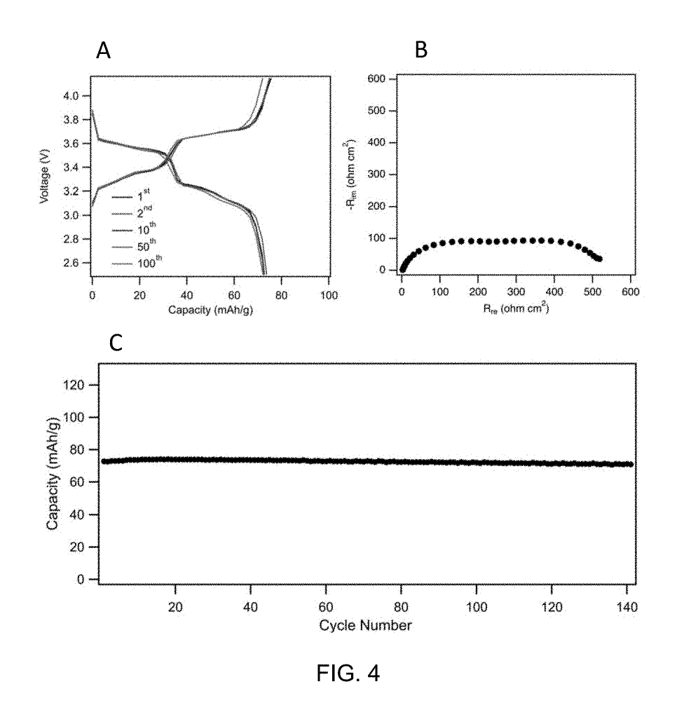

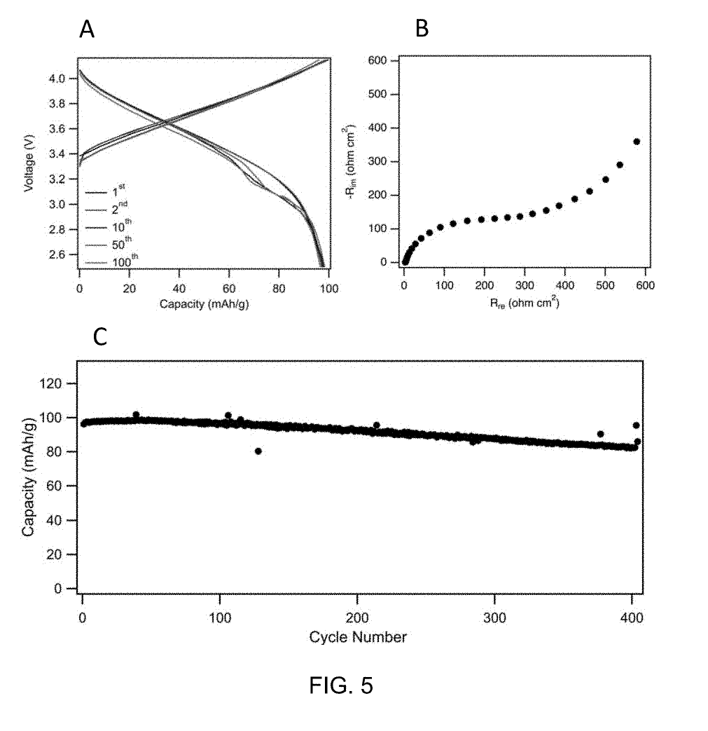

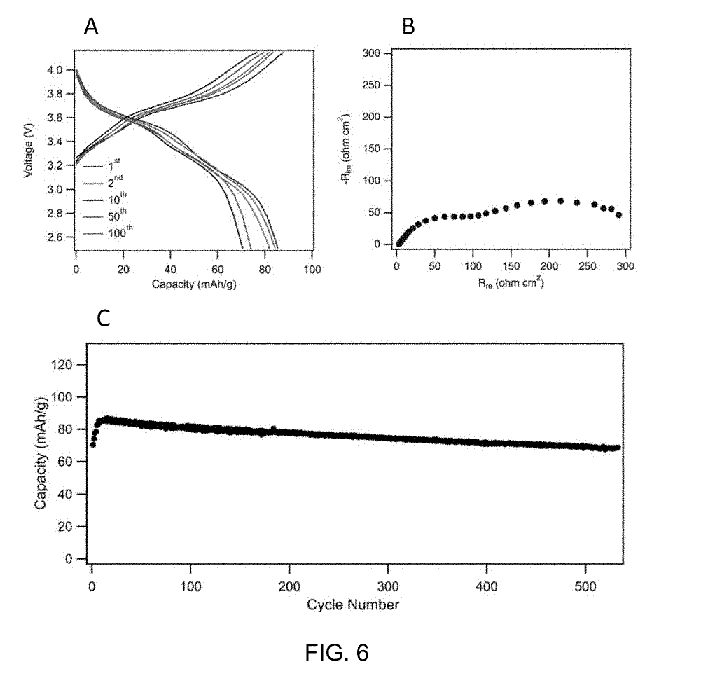

Electrochemical performance of the transition metal oxides in SIBs against a sodium metal counter electrode. FIGS. 3, 4, 5 and 6 depict voltage profiles of pristine NaNiMnXO₂ with different doping atoms for different cycles at 1C. (X=(FIG. 3) no doping, (FIG. 4) Si, (FIG. 5) Ti, (FIG. 6) Sn). FIG. 3 shows the charge/discharge profile of NaNM between 2.5 and 4.15 V, the impedance spectrum of the sodium ion battery using NaNM as the cathode and the capacity retention of NaNM cathode over 500 cycles at 1C. FIG. 4 shows the charge/discharge profile of NaNMSi between 2.5 and 4.15 V, the impedance spectrum of the sodium ion battery using NaNMSi as the cathode, and the capacity retention of NaNMSi cathode over 140 cycles at 1C. FIG. 5 shows the charge/discharge profile of NaNMTi between 2.5 and 4.15 V, the impedance spectrum of the sodium ion battery using NaNMTi as the cathode, and the capacity retention of NaNMTi cathode over 400 cycles at 1C. FIG. 6. shows the charge/discharge profile of NaNMSn between 2.5 and 4.15 V, the impedance spectrum of the sodium ion battery using NaNMSn as the cathode, and the capacity retention of NaNMSn cathode over 500 cycles at 1C.

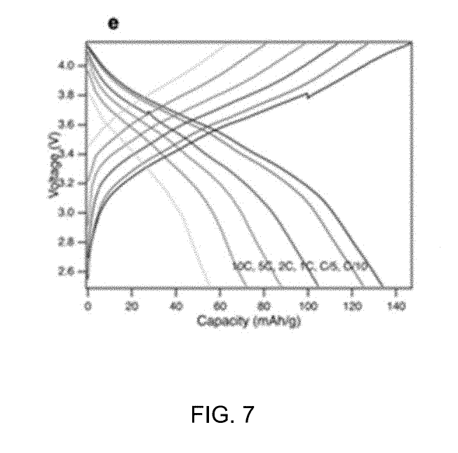

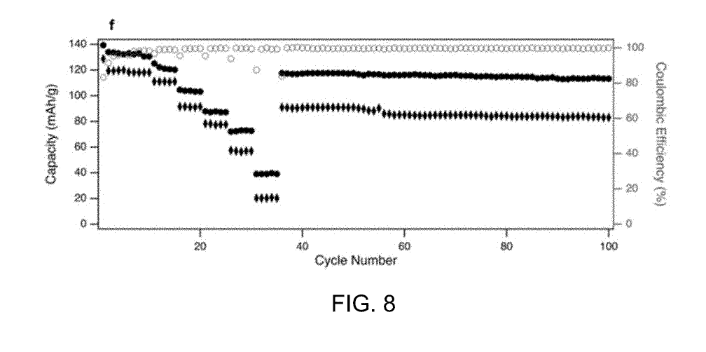

FIG. 7 shows voltage profiles of bio-NaNiMnTiO₂ at different rates. FIG. 8 shows cycling stability of pristine and bio-NaNiMnTiO₂ at different current densities (C/10, C/5, 1C, 2C, 5C, 10C and C/5).

To test the electrochemical performance of the synthesized material, coin cells were assembled with Na metal as the cathode and NaNiMnXO₂ as the anode. The cells were cycled in galvanostatic mode with a voltage range of 2.5V to 4.15 Von Solartron Analytical 1470E potentiostat at room temperature. The voltage profiles of the battery with different doping atom in the NaNiMnXO₂ are shown in FIGS. 4-6. The electrode material without doping displays a two plateau in the voltage, indicating a slow sodium ion kinetic in the electrode compound. With the addition of heteroatom, the voltage plateau becomes sloppy and consistent and the capacity increase with the addition of Ti. This indicates that heteroatom helps increase interatomic space and enhance sodium ion mobility in the compound. With the help of biotemplating, we were able to further increase the capacity and rate capability of the battery. As shown in FIGS. 7 and 8, the cell exhibits capacity of ˜120 mAh/g at a rate of C/5 with biotemplating. Bio-NaNiMnTiO₂ cathode can be cycled at a current density up to 10C and recover its capacity when lowing the rate. These results confirm the reversibility and rate capability of the bio-templated NaNiMnTiO₂ as the cathode of sodium-ion battery for the first time.

### Materials and Methods

### Materials

All the chemicals used in the synthesis were as received without further treatment. Tin (II) acetate (SnAc₂), ethylenediaminetetraacetic acid diasodium (EDTA-Na₂, ACS regent, 99-101.0%), nickel (II) acetate tetrahydrate (NiAc₂, 98%), manganese (II) acetate tetrahydrate (MnAc₂, 99%), tetraethyl orthosilicate (TEOS, 99.999%), titanium (IV) butoxide (TiBO, regent grade, 97%), and ethylene glycol (EG, anhydrous, 99.8%) were purchased from Sigma-Aldrich. Iron (II) acetate (FeAc₂, >90%) was purchased from Tokyo Chemical Industry Co (TCI). Isopropyl alcohol (IPA, ACS regent) was the product from Macron Fine Chemicals.

### Synthesis of NaNiMn Precursors

This synthesis enables of Ni, Mn and Na element ratio of NaNiMn precursors, for an example of Na_{2/3}Ni_{1/3}Mn_{1/3} described here. 2 mmol NiAc₂, 2 mmol MnAc₂ and 2.2 mmol EDTA-Na₂ (10% excess) were added in a flat bottom 250 mL containing 15 ML EG and 80 mL IPA. The flask was set in a silicone oil bath and kept the temperature at 90° C. for an hour while stirring the solution with Teflon coated magnet bar. After that, heating the solution at a temperature of 130° C. for an hour, then heating the solution at 160° C. for 10 hours. The final black viscous solution was used as NaNiMn precursors. During the heating process the flask cover was slight ajar to let vapor partially released.

### Synthesis of NaNiMnTi or NaNiMnSi Precursors

For preparing Na_{2/3}Ni_{1/3}Mn_{1/3}Ti_{1/3} or Na_{2/3}Ni_{1/3}Mn_{1/3} Si_{1/3}, 2 mmol NiAc₂, 2 mmol MnAc_{z} and 2.2 mmol EDTA-Na_{z} were added in a flat bottom 250 mL containing 15 ML EG and 80 mL IPA. The flask was set in a silicone oil bath and kept the temperature at 90° C. for an hour while stirring the solution with Teflon coated magnet bar. Next, the solution of 2 mmol TiBO (or TEOS) in 20 mL IPA was added into the solution and stirring another hour at 90° C. Then the solution was heated at a temperature of 130° C. for an hour, after then heating the solution at 160° C. for 10 hours.

### Synthesis of NaNiMnSn Precursors

For preparing Na_{2/3}N_{1/3}Mn_{1/3}Sn_{1/3} or Na_{2/3}Niᵥ₃Mn_{1/3}X_{1/3} (X=Fe, Sn, etc. . . . ), Metal acetate salts of NiAc₂, MnAc₂, and SnAc₂ each in 2 mmol amount together with 2.2 mmol EDTA-Na_{z} were added in a flat bottom 250 mL containing 15 ML EG and 80 mL IPA. The flask was set in a silicone oil bath and kept the temperature at 90° C. for an hour while stirring the solution with Teflon coated magnet bar. Next, the solution was heated at a temperature of 130° C. for an hour, after then heating the solution at 160° C. for 10 hours.

### Synthesis of P2-NaNiMn and NaNiMnTi (Sn, Si)

A part of NaNiMnX (X=Ti, Sn, Si, Fe, . . . ) precursors obtained above were further dried at a temperature ranged 200˜240° C. on the top of a hotplate or in a muffin furnace. After completely dried, the temperature of the muffin furnace was raised to 450° C. and kept the temperature for an hour. Then, muffin furnace temperature was raised to 950° C. and kept heating at the temperature for 10 hours. Or heating the sample in an open end tube furnace at 950° C. for 10 hours.

### Synthesis of M13-Virus Templated P2-NaNiMn and NaNiMnTi (Sn, Si)

1 mmol of NaNiMnX (X=Ti, Sn, Si, Fe, . . . ) precursors (Sixth in quantity of above precursors) was dispersed in 150 mL of IPA, and being ultrasonicated for 30 min. Then, the solution was set in an ice bath (temperature ˜0° C.) in the 4° C. cold room and kept stirring for more than 2 hours, then about 5×10¹⁴ M13-virus (at concentration >3.5×10¹³) was added into the solution with well dispersed NaNiMnX precursors. Let the virus incubate with the NaNiMnX precursors for 1 day and then separated virus templated NaNiMnX precursors through filtration or centrifugation.

The powder was collected and follow the above drying process of combustion and high temperature 950° C. solid reaction process, M13-virus templated P2-NaNiMn and NaNiMnTi (Sn, Si) were obtained.

### Material Characterization

JEOL 2010 and FEI Tecnai G2 were used to obtain TEM micrographs. XRD was done using the Panalytical Multipurpose Diffractometer.

### Electrochemical Characterization

2032 coin-type cells were assembled using sodium metal (Sigma-Aldrich) as the anode electrode, a glass fiber as the separator, a cathode composed of a mixture of the as-prepared composite, 10% Super-P Li carbon black (TIMCAL) and 10% poly(vinylidene difluoride) (Sigma-Aldrich), and an electrolyte of 100 μL of 1 M sodium perchlorate in ethylene carbonate/propylene carbonate (v/v=1:1) with 5 wt % fluoroethylene carbonate (Sigma-Aldrich) as the additive. Cell assembly was carried out in an argon-filled glovebox (MBraun Labmaster). The room-temperature cycling characteristics of the cells were evaluated under galvanostatic conditions using Land battery testers, and electrochemical processes in the cells were studied by cyclic voltammetry and impedance using a VMP300 Biologic electrochemical workstation.

Details of one or more embodiments are set forth in the accompanying drawings and description. Other features, objects, and advantages will be apparent from the description, drawings, and claims. Although a number of embodiments of the invention have been described, it will be understood that various modifications may be made without departing from the spirit and scope of the invention. It should also be understood that the appended drawings are not necessarily to scale, presenting a somewhat simplified representation of various features and basic principles of the invention.

What is claimed is:

1. A battery comprising:
a cathode including a NaTMO₂ layered oxide, wherein TM is one or more transition metals.

2. The battery of claim 1, wherein the NaTMO₂ layered oxide is P2-type.

3. The battery of claim 1, wherein the NaTMO₂ layered oxide is NaNiMnXO₂ where X is Ti, Fe, Sn, or Si.

4. The battery of claim 3, wherein X is present in a dopant amount in the NaTMO₂ composition.

5. The battery of claim 1, wherein a NaTMO₂ layered oxide is templated to a bacteriophage.

6. The battery of claim 1, wherein the battery is a sodium ion battery.

7. The battery of claim 1, wherein the battery has an energy density of more than 250 Wh/kg.

8. The battery of claim 1, wherein the NaTMO₂ has a particle size of between 5 nm and 50 nm.

9. A composition comprising:
a NaTMO₂ layered oxide, wherein TM is one or more transition metals.

10. The composition of claim 9, wherein the NaTMO₂ layered oxide is P2-type.

11. The composition of claim 9, wherein the NaTMO₂ layered oxide is NaNiMnXO₂ where X is Ti, Fe, Sn, or Si.

12. The composition of claim 9, wherein X is present in a dopant amount in the NaTMO₂ composition.

13. The composition of claim 9, wherein a NaTMO₂ layered oxide is templated to a bacteriophage.

14. The composition of claim 1, wherein the NaTMO₂ has a particle size of between 5 nm and 10 microns.
